(19) United States
(12) Patent Application Publication
(10) Pub. No.: US 2023/0127936 A1
(43) Pub. Date: Apr. 27, 2023

(54) SYSTEMS AND METHODS FOR CONTROLLING ELECTRONIC DEVICES USING GAZE TRACKING TECHNOLOGY

(71) Applicant: CamUX, Inc., Eden Prairie, MN (US)

(72) Inventors: Dimtry Ilchenko, Champaign, IL (US); Karolina Guerrero, Chicago, IL (US); Ryan Prendergast, Park Ridge, IL (US); Siddharth Bhujle, Eden Prairie, MN (US)

(21) Appl. No.: 17/966,788

(22) Filed: Oct. 15, 2022

Related U.S. Application Data
(60) Provisional application No. 63/270,055, filed on Oct. 21, 2021.

(51) Int. Cl. G06F 3/01; G06T 7/70

(52) U.S. Cl. CPC G06F 3/015; G06F 3/017; G06T 7/70

(57) ABSTRACT

A system and method for controlling computers or other similar electronic devices using gaze tracking technology are provided. In the system, an eye camera records images of a user's eye, and a scene camera records images of the objects in front of the user. A computing unit calculates a gaze vector representing the user's pupil position and uses a predetermined equation to calculate a set of screen coordinates. The computing unit also determines whether the user's head has moved and adjusts the screen coordinates determined earlier based on how the user's head has moved. A cursor is displayed on the screen of a computer at the location represented by the adjusted coordinates. A joystick with a movable handle is also included in the system, and the user may move the handle to predetermined directions to input desired data on the computer.

### CROSS-REFERENCE TO RELATED APPLICATIONS

This application claims priority to U.S. provisional application No. 63/270,055, filed Oct. 21, 2021 entitled Systems and Methods for Controlling Electronic Devices Using Gaze Tracking Technology” which is incorporated by reference herein.

### FIELD OF THE INVENTION

The present invention generally relates to systems and methods for controlling computers and other electronic devices using gaze tracking technology.

### BACKGROUND OF THE INVENTION

Mice and keyboards are the most common ways of interacting with computers, but using them can be challenging for people with physical, sensory, or cognitive disabilities. Using traditional mice and keyboards is extremely difficult for people with upper body functional limitations. Therefore, alternatives for mouse and keyboard have been developed to help people with special needs. Joysticks have long been used as an alternative to mice due to their similarity to electric wheelchair controls. In recently years, gaze tracking technologies have been used as a new way to control computers and other electronic devices, such as tablets and TVs. However, there is a need to improve on the current gaze tracking technologies.

### SUMMARY OF THE INVENTION

In accordance with an embodiment of the present disclosure, a computer input system is disclosed. The system including: a joystick including a handle, wherein said handle is displaceable to actuate one of a plurality of switches, wherein each of said plurality of switches represents a different computer interface display command and generates computer interface display command data representing said computer interface display command when said the switch is actuated; an eye camera positioned to record a current eye image of the eye of a user observing said computer interface display image, wherein said current eye image includes a current pupil position of said eye; a computing unit, wherein said computing unit receives said current eye image, compares said current pupil position of said eye to a predetermined dataset representing a conversion of said current pupil position to a current user gaze location to determine a current user gaze location; and a computer system displaying a computer interface display image on a display, wherein said computer system receives said current user gaze location from said computing unit and displays a cursor at said current user gaze location on said display, wherein said computer system receives said interface display command data from said joystick and executes said computer interface display command at said current user gaze location on said display.

In accordance with an embodiment of the present disclosure, a method is disclosed for inputting data in a computer. The method includes: recording images of at least one of the user's eyes; determining at least one gaze vector describing the user's pupil position from the images of the user's eyes by executing a prestored pupil detection program; determining a set of screen coordinates based on at least one gaze vector and a predetermined equation describing the correlation between the gaze vector and the screen coordinates; and displaying a cursor on a display at the screen coordinates

One or more of the embodiments of the present invention provide a system or method for inputting data into computers or other electronic devices such as tablets, smartphones or TVs. Specifically, the system tracks a user's eye movement, determines the user's gaze direction (i.e., where the user is looking at), and displays a cursor at the location the user is viewing on a display. The system includes a head mounted frame, an eye camera, a scene camera, a computing unit, a joystick, a control unit and a computer. The computer includes a processing unit and a display.

In operation, the eye camera records images of one of a user's eyes, and the scene camera records images of the objects in front of the user. The computing unit then calculates a gaze vector representing the user's pupil position from the images of one of the user's eyes. Next, the computing unit calculates a set of screen coordinates representing the user's gaze direction based on the gaze vector and a predetermined equation representing the correlation between the gaze vector and the screen coordinates. The computer receives the screen coordinates from the computing unit and moves a cursor to a location represented by the screen coordinates.

The joystick has a handle that may be moved to predetermined directions, and it sends an electronic signal when the handle has been moved. The control unit receives the screen coordinates and the electronic signal and generates an input command preassigned to the electronic signal from the joystick. The computer receives the input command from the control unit and executes the input command.

### BRIEF DESCRIPTION OF THE DRAWINGS

FIG. 1 illustrates a system for controlling a computer using gaze tracking technology according to an embodiment of the present invention.

FIG. 2 illustrates a flow chart of a calibration process according to one embodiment of the present invention.

FIG. 3 illustrates a flow chart of a process for moving a cursor to a desired location according to one embodiment of the present invention.

FIG. 4 illustrates a flow chart of a process for inputting data using the joystick according to one embodiment of the present invention.

FIG. 5 shows a front view of a gaze tracking device according to one embodiment of the present invention.

FIG. 6 shows a side view of the gaze tracking device shown in FIG. 5.

FIG. 7 shows an electronic device control system according to one embodiment of the present invention.

FIG. 8 shows a top plan view of a gaze tracking device according to another embodiment of the present invention.

FIG. 9 shows a back view of the gaze tracking device shown in FIG. 8.

### DETAILED DESCRIPTION OF THE INVENTION

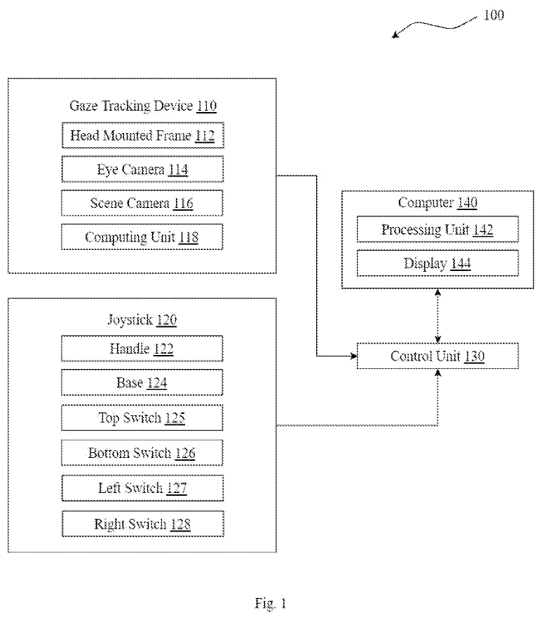

FIG. 1 illustrates an electronic device control system 100 according to an embodiment of the present invention. The system 100 includes a gaze tracking device 110, a joystick 120, a control unit 130 and a computer 140. The gaze tracking device 110 includes a head mounted frame 112, an eye camera 114, a scene camera 116, and a computing unit 118. In the present embodiment, the head mounted frame 112 is a pair of glasses, the eye camera 114 and the scene camera 116 are Camera Module V2 from Raspberry Pi as examples, and the computing unit 118 is for example, a Jetson platform from NVIDIA. The joystick 120 includes a handle 122, a base 124, a top switch 125, a bottom switch 126, a left switch 127 and a right switch 128. In the present embodiment, the joystick is an American style 8-way arcade joystick. The control unit 130 is a microcontroller. In the present embodiment, the control unit 130 is a ESP32 microcontroller for example. The computer 140 includes a processing unit 142 and a display 144. In the present embodiment, the computer 140 is a desktop personal computer.

In the present embodiment of system 100, the gaze tracking device 110 and the joystick 120 are electronically connected to the control unit 130. The control unit 130 communicate via Bluetooth wireless, with the computer 140. The eye camera 114 is positioned on the head mounted frame 112, with its lens pointing at one of a user's eyes. The scene camera 116 is positioned on the head mounted frame, with its lens pointing to the objects in front of the user. The eye camera 114 and the scene camera 116 are electronically connected to the computing unit 118. The handle 122 has a fixed end attached to the base 124, and a movable end that may be moved to multiple predetermined directions.

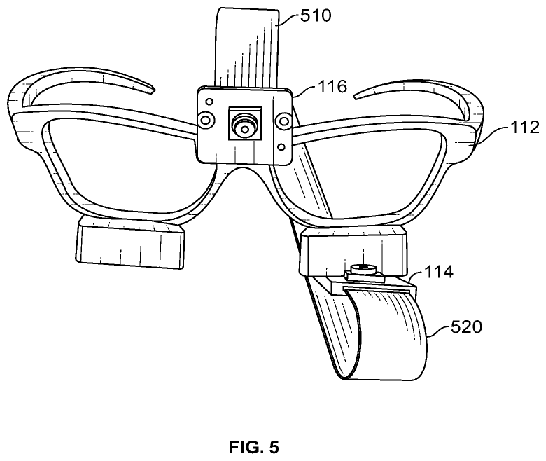

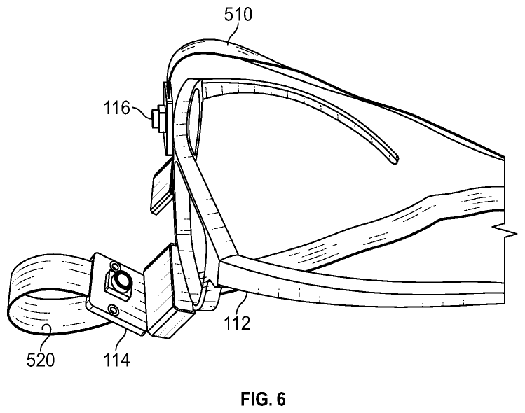

In operation, a user wears the system 100 on the head. The user is directed to go through a calibration process first. In the calibration process, the computing unit 118 generates a random set of coordinates that describe a predetermined location on the display 144. The computing unit 118 then sends the coordinates to the control unit 130. The control unit 130 then sends the coordinates to the computer 140. The processing unit 142 receives the coordinates and instructs the display 144 to display a calibration marker on the location described by the coordinates. The user is directed to look at the marker on the display 144. The eye camera 114 then records images of the user's eye. The computing unit 118 then receives the images of the user's eye from the eye camera 114. In the present embodiment, the eye camera 114 is directly connected to the computing unit 118 by a ribbon connector (shown in FIGS. 5 and 6) for example, and the computing unit 118 has driver support for the eye camera 114 so that it takes images directly from the eye camera 114. The computing unit 118 then executes a prestored pupil detection program to determine the position of the user's pupil using the images from the eye camera 114. In the present embodiment, the prestored pupil detection program is Pupil Lab's pye3d pupil detection software, and the user's pupil position is described by a 3D gaze vector. Specifically, the pye3d software firstly outputs a result indicating whether a pupil has been detected. When the output indicates that no pupil has been detected, it indicates that the eye camera 114 is not operating under optimal working conditions. When the output indicates that a pupil has been detected, the pye3d software creates a 3D eye positional model using the data in the images and calculates a 3D gaze vector that describes the pupil's position. The computing unit 118 then generates another random set of coordinates, and the process described above is repeated. In the present embodiment, the process is done for ten times in total, so ten pairs of coordinates describing screen locations, i.e., screen coordinates, and gaze vectors are generated and calculated. However, those skilled in the art know that the process may be performed any number of times to achieve desired results.

The computing unit 118 then executes a gaze mapping program to determine the correlations between a screen location and gaze vector. In this process, the ten pairs of screen coordinates and gaze vectors are used to determine unknown coefficients in two predetermined polynomials. In the present embodiment, the gaze mapping program uses the following polynomials to describe the correlation:

X=AXₑ³+BYₑ³+CZₑ³+DXₑ²±EYₑ²+FZₑ²+GXₑ+HYₑ+IZₑ (1)

Y=A′Xₑ³+B′Yₑ³+C′Zₑ³+D′Xₑ²+E′Yₑ²+F′Zₑ²+G′Xₑ+H′Yₑ+I′Zₑ (2)

In equations (1) and (2) above, X and Y are the X-coordinate and Y-coordinate of the screen coordinates respectively; Xₑ, Yₑ, and Zₑ are the X-coordinate, Y-coordinate, and Z-coordinate of the gaze vector respectively. A, A′, B, B′, C, C′ . . . I, I′ are unknown coefficients. The gaze mapping program uses the Levenberg-Marquardt algorithm and the ten pairs of screen locations and gaze vectors, i.e., ten different values of X, Y, Xₑ, Yₑ, Zₑ to solve the coefficients A, A′, B, B′, C, C′ . . . I, I′ and determines the polynomials that best describe the correlations between a screen location and a gaze vector of the user. After the execution of the gaze mapping program, two polynomials are determined for the X-coordinate and Y-coordinate of the screen coordinates respectively. These two polynomials are then saved in the memory of the computing unit 118 for later uses.

During the calibration process, the user is directed not to move the user's head so that the head position remains constant throughout the process. The scene camera 116 then records images of the objects in front of the user while the above calibration process is occurring. The computing unit 118 receives the images from the scene camera 116. In the present embodiment, similar to the eye camera 114, the scene camera 116 is directly connected to the computing unit by a ribbon connector (shown in FIGS. 5 and 6), and the computing unit 118 has driver support for the scene camera 116 so that it takes images directly from the scene camera 116. The computing unit 118 then uses a specific object in the images as a reference to describe the user's head position. In the present embodiment, the display 144 itself is used as the reference, and the coordinates of the middle point of the display 144's four borders are used as the basis to determine whether the user's head has moved at a later time (further illustrated below). The computing unit 118 determines the coordinates of the display 144's four middle points respectively and these four sets of coordinates are saved in the memory of the computing unit 118 for later uses.

After the calibration process, when the user looks at any location on the display 144, the eye camera 114 again records images of the user's eye. The computing unit 118 then receives the images from the eye camera 114 and executes the prestored pupil detection program to calculate a gaze vector describing the position of the user's pupil by executing the pupil detection software as illustrated above. The computer unit 118 then calculates a set of coordinates (X, Y) describing the location the user is looking at on the display 144 using the polynomials determined in the calibration process and the gaze vector. This location is saved as P (X, Y) in the computing unit 118 for later uses.

When the user is looking at the location P (X, Y), the scene camera 116 records images of the objects in front of the user. The computing unit 118 receives images from the scene camera 116 and determines whether the user's head position has changed compared to the user's head position during the calibration process by using the following method: first, the computing unit 118 determines the coordinates of the middle point of the display 144's four borders. The computing unit 118 then compares these four sets of coordinates to the coordinates of the corresponding middle points of the borders determined in the calibration process. For example, the coordinates of the middle point of the left border are compared to the coordinates of the middle point of the left border determined during the calibration process. When none of the coordinates has changed, it indicates that the user's head position is the same as that during the calibration process, and no adjustment is made. When any of the four sets of coordinates has changed, it indicates that the user's head position has changed, and adjustment is made to P's coordinates by the following methods: for lateral movements, the width of the display 144 in the image and the lateral movement of the middle point of the display 144's left and right border's is calculated. The width and the movements are measured by pixels. Next, the average of their movements is determined, and the averaged movement is then compared to the width of the screen image to determine the relative movement in percentages. Finally, P's X-coordinate will be moved to the opposite direction by the same percentage. For example, when the width of the display 144 in the image is 1,000 pixels and the middle point of the display 144's left and right border has moved to the left by 5 pixels and 4 pixels respectively, the average movement is (4+5)/2=4.5, and the display 144 is determined to have moved to the left by 4.5/1,000=0.45%. In this case, P's X-coordinate will be moved to the right by 0.45%. When the display's left and right borders have moved the opposite direction, the net movement is used for the basis. For example, when the left border has moved to the left by 5 pixels, and the right border has moved to the right by 4 pixels, the net movement is 1 pixel to the left, and the average movement is 0.5 pixel to the left. For vertical movements, the same adjustment method is employed using the movement of the top and bottom border of the display, and P's Y-coordinate is moved up or down accordingly. After the adjustment, P's new location is saved as P′ (X′, Y′). The computer unit 118 then sends the coordinates of P′, or P when no adjustments are needed, to the control unit 130. The control unit 130 then sends the coordinates to the computer 140. The processing unit receives the coordinates and instructs the display 144 to move a cursor to the location which the coordinates describe.

In operation, a user may actuate the joystick 120 by moving the handle 122 to one of multiple predetermined directions, and a specific input command is preassigned to each direction. The joystick 120 has a 4-way mode in which the handle 122 may be moved to four directions, up, down, left, and right, and an 8-way mode in which the handle 122 may be moved to eight directions, up, down, left, right, a direction between up and left, left and down, down and right, right and up respectively. In the present embodiment, the joystick is in the 4-way mode. A scrolling up command is assigned to the up movement, a scrolling down command is assigned to the down movement, a left click command is assigned to the left movement, and a right click command is assigned to the right movement. When the user moves the handle 122 to a predetermined direction, the handle 122 actuates a switch associated with that specific predetermined direction by pushing the switch, and the switch sends a signal to the control unit 130. The control unit 130 then recognizes which switch is actuated and determine which direction the handle 122 has been moved based on which switch has been actuated. After the control unit 130 determines the direction, it retrieves the input command preassigned to that direction and sends the input command to the computer 140. The processing unit 142 then receives the input command and performs the received input command. For example, when the user moves the handle 122 to the left, the handle 122 actuates the left switch 127, and the left switch sends a signal to the control unit 130. The control unit 130 receives the signal and recognizes that the left switch 127 has been actuated. The control unit 130 then determines that the handle 122 has been moved to the left, retrieves the input command preassigned to the left direction, which is left click, and sends the left click input command to the computer 140. The processing unit 142 then receives the left click command and performs a left click input command.

In an alternative embodiment of the present invention, the head mounted frame 112 is a 3D printed frame configured to be worn on a user's head.

In an alternative embodiment of the present invention, a second eye camera is mounted on the head mounted frame 112 to increase accuracy and reliability in case one of the cameras is not working under optimal operating conditions. In this embodiment, the camera records images of a user's both eyes. In the calibration process, the polynomials describing the correlation between screen coordinates and gaze vector are determined for each eye by the method illustrated above. After the calibration process, when the user starts to use the system 100 and looks at any location on the display 144, the additional camera and the eye camera 114 record images of the user's both eyes at a predetermined frame rate. The computing unit 118 then receives the images from the eye camera 114 and the additional camera. The computing unit 118 then executes the prestored pupil detection program, and the pupil detection program analyzes the data in the images from each camera separately. In this embodiment, the pye3d software is used, but other software may be used as known to those skilled in the art. As illustrated above, when the pupil detection program indicates that a pupil has been detected, it calculates a gaze vector describing the position of the pupil. When a pupil has been detected based on images from both cameras individually, the pupil detection program calculates two gaze vectors based on the data from each camera respectively. Instead of calculating a set of coordinates describing a screen location P (X, Y), the computer unit 118 calculates two sets of coordinates describing two screen locations, P₁ (X₁, Y₁) and P₂ (X₂, Y₂), based on the two gaze vectors and the polynomials for each eye determined earlier. The computing unit 118 then determines a new point P₃ by averaging the coordinates of P₁ and P₂. This new point, P₃ ((X₁+X₂)/2, (Y₁+Y₂)/2), is used as the basis for the adjustments at the later steps. When the pupil detection program indicates that a pupil has been detected from images from only one of the cameras, the computing unit only uses the images from that camera, and the process is the same as that illustrated above.

In an alternative embodiment of the present invention, the joystick 120 is in the 8-way mode, and additional input commands, such as double click, copy, and paste, are preassigned to the additional directions which enable a user to input more data using the joystick 120.

In another alternative embodiment of the present invention, the system 100 further includes a user interface which enables a user to change the input commands assigned to each moving direction.

In another alternative embodiment of the present invention, the computer 140 is a tablet, a smartphone, a laptop, a flat screen TV, or any other similar electronic devices known to those skilled in the art.

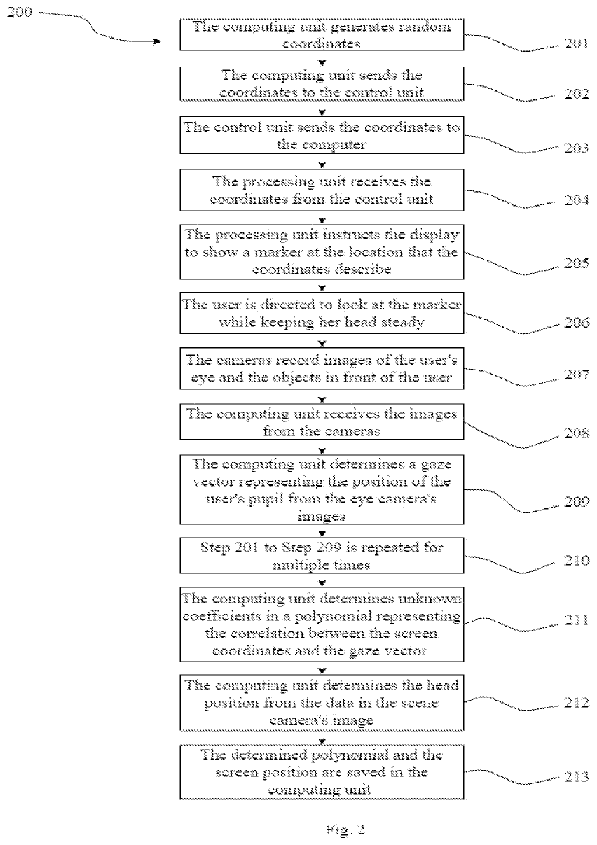

FIG. 2 illustrates a flow chart 200 of a calibration process according to an embodiment of the present invention. At step 201, the computing unit 118 generates a random set of coordinates that describes a predetermined location on a display. At step 202, the computing unit sends the coordinates generated at step 201 to the control unit 130. At step 203, the control unit sends the coordinates to the computer 140. At step 204, the processing unit 142 receives the coordinates from the control unit 130. At step 205, the processing unit 142 instructs the display 144 to display a marker at the location the coordinates describe. At step 206, a user is directed to look at the marker on the display 144 while keeping the user's head steady. At step 207, the eye camera 114 and the scene camera 116 record images of one of the user's eye and the objects in front of the user respectively. At step 208, the computing unit 118 receives the images from the cameras. At step 209, the computing unit 118 executes a prestored pupil detection program to determine the position of the user's pupil from the data in the images as illustrated above. At step 210, the process from step 201 to step 209 is repeated multiple times. In the present embodiment, the process is repeated ten times to determine ten pairs of gaze vectors and screen coordinates. At step 211, the computing unit 118 executes a gaze mapping model to determine the unknown coefficients in two predetermined polynomials describing the correlation between screen coordinates and gaze vector. In the present embodiment, the polynomials are equations (1) and (2) described above, and the coefficients are determined by the Levenberg-Marquardt algorithm using the ten pairs of gaze vectors and screen coordinates determined at step 210. At step 212, the computing unit 118 determines the user's head position by determining the coordinates of the middle point of each border of the display 144 in the images recorded by the scene camera 116. At step 213, the polynomial determined at step 211 and the coordinates determined at step 212 are saved to the memory of the computing unit 118 for later uses.

In an alternative embodiment of the present invention, an additional eye camera is added to record images of the user's other eye. Therefore, at step 209, a gaze vector is determined for each eye; at step 210, a polynomial representing the correlation between the screen coordinates and the gaze vector is also determined for each eye.

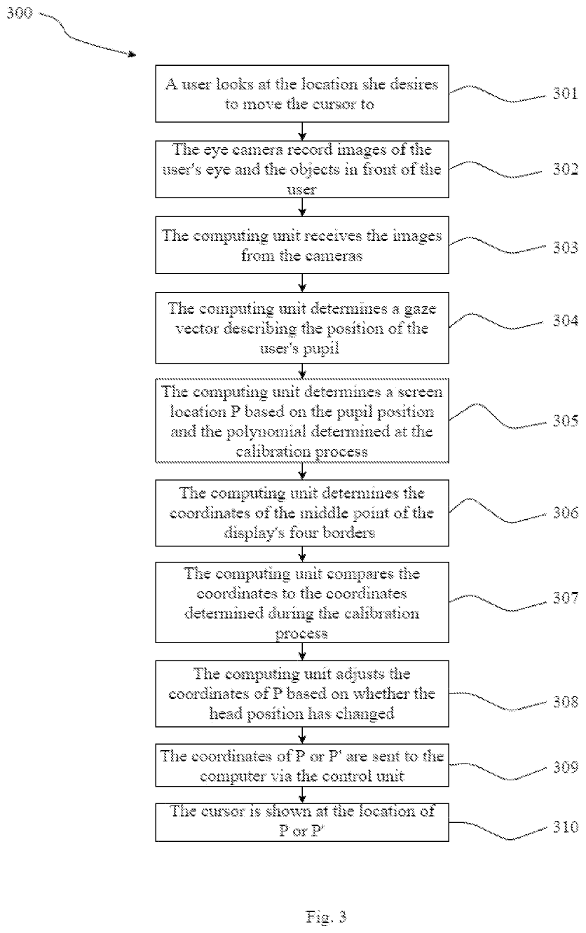

FIG. 3 illustrates a flow chart 300 of a process for moving a cursor to a desired location according to an embodiment of the present invention. At step 301, a user looks at the location the user desires to move a cursor to that location. At step 302, the eye camera 114 and the scene camera 116 record images of the user's eye and the objects in front of the user respectively. At step 303, the computing unit 118 receives the images from the eye camera 114 and the scene camera 116. At step 304, the computing unit 118 executes a prestored pupil detection program to determine the position of the user's pupil from the data in the images as illustrated above. The position of the user's pupil is described by a gaze vector. At step 305, the computing unit 118 determines a screen location P (X, Y) based on the gaze vector determined at step 304 and the polynomial describing the correlation between the gaze vector and the screen coordinates. This polynomial is determined at step 213 in the calibration process. At step 306, the computing unit 118 determines the coordinates of the middle point of the display 144's four corners based on the data in the scene camera 116's images. At step 307, the computing unit 118 compares the coordinates determined at step 306 to the coordinates determined at step 213 in the calibration process. At step 308, P's coordinates are adjusted based on the method illustrated above. At step 309, the coordinates of P, or P′ when adjustments are needed due to head position changes, are sent to the computer 140 via the control unit 130. At step 310, the computer 140 displays a cursor at the location of P or P′.

In an alternative embodiment of the present invention, an additional eye camera is added to record images of the user's other eye. Therefore, at step 304, when a pupil has been detected based on images from both cameras respectively, the computing unit 118 generates two gaze vectors describing the position of each pupil respectively. At step 305, instead of determining one screen location P (X, Y), the computer unit 118 determines two screen locations, P₁ (X₁, Y₁) and P₂ (X₂, Y₂), based on the two gaze vectors and the polynomials for each eye determined at step 210 in the calibration process. The computing unit 118 then determines a new screen location P₃ by averaging the coordinates of P₁ and P₂. This new screen location, P₃ ((X₁+X₂)/2, (Y₁+Y₂)/2), is used as the basis for the adjustments at the later steps. When only one of the cameras can provide images with good quality, the process is the same as that illustrated above.

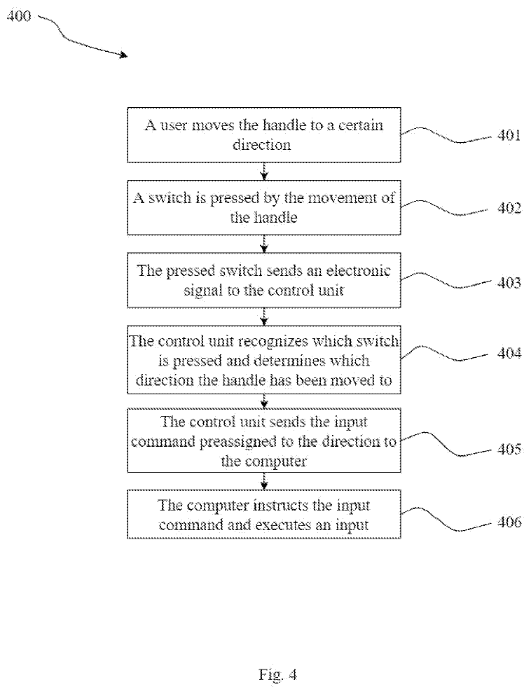

FIG. 4 illustrates a flow chart 400 of a process for inputting data using the joystick 120 according to an embodiment of the present invention. At step 401, a user moves the handle 122 to a predetermined direction. In the present embodiment, the handle 122 is movable to 4 directions: up, down, left, and right. At step 402, a switch is actuated by the movement of the handle 122. For example, when the handle 122 is moved to the left, the handle 122 presses the left switch 127. At step 403, the pressed switch sends an electronic signal to the control unit 130. At step 404, the control unit 130 receives the signal, recognizes which switch is pressed, and determines which direction the handle has been moved. At step 405, the control unit 130 sends the input command preassigned to the direction determined at step 404 to the computer 140. At step 406, the computer 140 receives the command, instruct the input command, and executes an input.

In an alternative embodiment of the present invention, at step 401, the handle 122 is movable to eight directions: up, down, left, right, a direction between up and left, left and down, down and right, right and up respectively.

In another alternative embodiment of the present invention, before step 401, the input command assigned to each direction may be changed by a user.

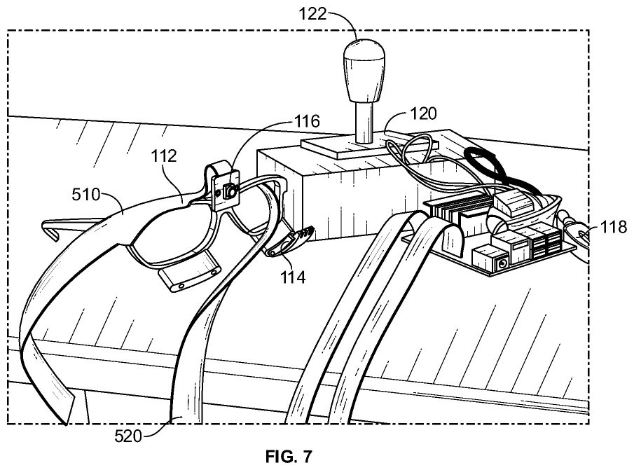

FIGS. 5 and 6 show a front view and a side view of a gaze tracking device 110 respectively according to one embodiment of the present invention. In this embodiment, the gaze tracking device 110 includes the head mounted frame 112, the eye camera 114, the scene camera 116, a scene camera connector 510 and an eye camera connector 520. The eye camera 114 is connected to the computing unit 118 (shown in FIG. 7) by the eye camera connector 520. The scene camera is connected to the computing unit 118 by the scene camera connector 510.

FIG. 7 shows an electronic device control system 100 according to one embodiment of the present invention. In addition to the head mounted frame 112, the eye camera 114, the scene camera 116, a scene camera connector 510 and an eye camera connector 520 as shown in FIGS. 5 and 6, the computing unit 118 and the joystick 120 with the handle 122 are further shown.

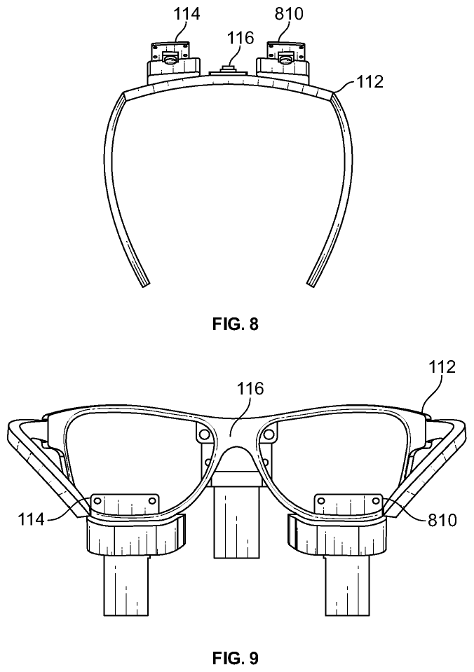

FIGS. 8 and 9 show a top view and a back view of a gaze tracking device 110 respectively according to one embodiment of the present invention. In this embodiment, in addition to the head mounted frame 112, the eye camera 114, the scene camera 116, the gaze tracking device 110 further includes a second eye camera 810 mounted on the head mounted frame 112, with its lens facing to the user's other eye.

The systems and methods disclosed herein for gaze tracking or controlling computers or other electronic devices using gaze tracking technologies do not require multi-step initial setup or complicated actions from users to work properly. (That is, such systems are easy to set up and easy to use.) This improves useability for people with special needs and operation simplicity to use such systems properly and efficiently. In addition, there is no need for multiple high-end sensors with the systems and methods described herein. Therefore, the cost of such systems and methods has been reduced, which offers better use options for people with physical limitations. Further, the systems and methods described here (one or more embodiments of the present invention) are highly modular and employs affordable components, which lowers the total cost of the systems significantly.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A computer input system, the system including:
a joystick including a handle, wherein said handle is displaceable to actuate one of a plurality of switches, wherein each of said plurality of switches represents a different computer interface display command and generates computer interface display command data representing said computer interface display command when said the switch is actuated;
an eye camera positioned to record a current eye image of the eye of a user observing said computer interface display image, wherein said current eye image includes a current pupil position of said eye;
a computing unit, wherein said computing unit receives said current eye image, compares said current pupil position of said eye to a predetermined dataset representing a conversion of said current pupil position to a current user gaze location to determine a current user gaze location; and
a computer system displaying a computer interface display image on a display, wherein said computer system receives said current user gaze location from said computing unit and displays a cursor at said current user gaze location on said display, wherein said computer system receives said interface display command data from said joystick and executes said computer interface display command at said current user gaze location on said display.

2. The system of claim 1, further comprising:
a scene camera, wherein said scene camera records images of the objects in front of said user; wherein said computing unit determines the head position of said user from said images of the objects in front of said user and adjusts said current user gaze location based on said head position of said user.

3. The system of claim 2, further comprising:
a second eye camera, wherein said second eye camera records images of said user's other eye, wherein said computing unit determines said current gaze direction based on the position of said user's both pupils.

4. The system of claim 2, further comprising:
a wireless module, wherein said wireless module receives data from said control unit and sends said data to said computer system via wireless network.

5. The system of claim 3, further comprising:
a wireless module, wherein said wireless module receives data from said control unit and sends said data to said computer system via wireless network.

6. The system of claim 2, further comprising:
a Bluetooth module, wherein said Bluetooth module takes data from said control unit and sends said data to said computer system via Bluetooth.

7. The system of claim 3, further comprising:
a Bluetooth module, wherein said Bluetooth module receives data from said control unit and sends said data to said computer system via Bluetooth.

8. The system of claim 2, further comprising:
a user interface, wherein said user interface enables a user to change the input commands preassigned to the electronic signal.

9. A method for inputting data in a computer, the method including:
recording images of at least one of the user's eyes;
determining at least one gaze vector describing the user's pupil position from the images of the user's eyes by executing a prestored pupil detection program;
determining a set of screen coordinates based on at least one gaze vector and a predetermined equation describing the correlation between the gaze vector and the screen coordinates; and
displaying a cursor on a display at the screen coordinates.

10. The method of claim 9, further including:
recording images of the objects in front of the user;
determining a specific object in the images as a reference;
determining the user's head movement by determining the movement of the specific object; and
adjusting the screen coordinates based on the user's head movement.

11. The method of claim 10, further including:
moving a joystick handle to a predetermined direction;
sending an electronic signal preassigned to the direction in which the joystick is moved;
sending an input command preassigned to the electronic signal; and
executing an input on a computer.
